(19) United States
(12) Patent Application Publication
(10) Pub. No.: US 2026/0119741 A1
(43) Pub. Date: Apr. 30, 2026

(54) MODELING DEVICE FOR BRAIDED SHIELD ELECTRIC WIRE, MODELING METHOD FOR BRAIDED SHIELD ELECTRIC WIRE, AND MODELING PROGRAM FOR BRAIDED SHIELD ELECTRIC WIRE

(71) Applicant: Yazaki Corporation, Tokyo (JP)

(72) Inventors: Katsuya KOMAI, Shizuoka (JP); Yurie Takayama, Shizuoka (JP); Norihiro Tozawa, Shizuoka (JP)

(73) Assignee: Yazaki Corporation, Tokyo (JP)

(21) Appl. No.: 19/369,509

(22) Filed: Oct. 27, 2025

(30) Foreign Application Priority Data
Oct. 29, 2024 (JP) 2024-189453

(51) Int. Cl. G06F 30/20; G06F 111/10; G06F 113/16

(52) U.S. Cl. CPC G06F 30/20; G06F 2111/10; G06F 2113/16

(57) ABSTRACT

A simulation device that is a modeling device for a braided shield electric wire includes a model creation unit that creates a braided shield electric wire model for reproducing a current flowing through a braided shield for the braided shield electric wire. The braided shield electric wire model includes a core line model corresponding to a core line, an insulator model corresponding to an insulator, and a braided shield model corresponding to the braided shield. The braided shield model includes a plurality of strand band models in which a strand bundle is modeled into a band shape. The strand band models are separated from each other.

### CROSS-REFERENCE TO RELATED APPLICATION(S)

The present application claims priority to and incorporates by reference the entire contents of Japanese Patent Application No. 2024-189453 filed in Japan on Oct. 29, 2024.

### BACKGROUND OF THE INVENTION

### 1. Field of the Invention

The present invention relates to a modeling device for a braided shield electric wire, a modeling method for the braided shield electric wire, and a modeling program for the braided shield electric wire.

### 2. Description of the Related Art

For example, as a conventional technology related to a modeling device for a braided shield electric wire, Japanese Patent Application Laid-open No. 2023-144343 (JP 2023-144 343 A) discloses a modeling device for a braided shield electric wire including a model creation unit that creates a braided shield electric wire model. The model creation unit creates a braided shield electric wire model that includes a first layer in which a plurality of first strand bundle models are spirally formed along a first direction around the axis of a core line model, and a second layer provided outside the above-described first layer in a state of being separated from the first layer and in which a plurality of second strand bundle models are spirally formed along a second direction in the direction opposite to the first direction around the axis of the core line model, and in which the first strand bundle model of the first layer and the second strand bundle model of the second layer are not braided.

For example, such a modeling device for the braided shield electric wire may take time to create models for a large number of strands, and there is room for further improvement in terms of modeling a braided shield electric wire.

### SUMMARY OF THE INVENTION

The present invention has been made in view of the above circumstances, and an object of the present invention is to provide a modeling device for a braided shield electric wire, a modeling method for the braided shield electric wire, and a modeling program for the braided shield electric wire that can properly shorten the time required for modeling the braided shield electric wire.

In order to achieve the above mentioned object, a modeling device for a braided shield electric wire according to one aspect of the present invention includes a model creation unit that creates a braided shield electric wire model for reproducing a current flowing through a braided shield for a braided shield electric wire that includes a conductive core line, an insulator that covers a periphery of the core line, and the braided shield provided on a periphery of the insulator and that is provided with a plurality of strand bundles formed by bundling a plurality of strands, wherein the braided shield electric wire model includes a core line model corresponding to the core line, an insulator model corresponding to the insulator, and a braided shield model corresponding to the braided shield, the braided shield model includes a plurality of strand band models in which the strand bundle is modeled into a band shape, and the strand band models are separated from each other.

In order to achieve the above mentioned object, a modeling method for the braided shield electric wire according to another aspect of the present invention includes when creating a braided shield electric wire model for reproducing a current flowing through a braided shield for the braided shield electric wire that includes a conductive core line, an insulator that covers a periphery of the core line, and the braided shield provided on a periphery of the insulator and that is provided with a plurality of strand bundles formed by bundling a plurality of strands, a model creation step that creates the braided shield electric wire model including a core line model corresponding to the core line, an insulator model corresponding to the insulator, and a braided shield model corresponding to the braided shield, wherein at the model creation step, the braided shield model includes a plurality of strand band models in which the strand bundle is modeled into a band shape, and the strand band models are separated from each other.

In order to achieve the above mentioned object, a modeling program for the braided shield electric wire according to still another aspect of the present invention includes when creating a braided shield electric wire model for reproducing a current flowing through a braided shield for the braided shield electric wire that includes a conductive core line, an insulator that covers a periphery of the core line, and the braided shield provided on a periphery of the insulator and that is provided with a plurality of strand bundles formed by bundling a plurality of strands, a model creation step that creates the braided shield electric wire model including a core line model corresponding to the core line, an insulator model corresponding to the insulator, and a braided shield model corresponding to the braided shield, wherein at the model creation step, the braided shield model includes a plurality of strand band models in which the strand bundle is modeled into a band shape, and the strand band models are separated from each other.

### BRIEF DESCRIPTION OF THE DRAWINGS

FIG. 1 is a block diagram illustrating a configuration example of a simulation device for a braided shield electric wire according to an embodiment.

FIG. 2 is a perspective view illustrating a configuration example of a braided shield electric wire to be modeled.

FIG. 3 is a perspective view illustrating a configuration example of a braided shield electric wire model according to the embodiment.

FIG. 4 is a sectional view cut along a line IV-IV in FIG. 3.

FIG. 5 is a diagram illustrating the length of the circumference of a strand around the axis of a core line of the braided shield electric wire according to the embodiment.

FIG. 6 is an explanatory diagram for explaining the calculation of a band cross-section.

FIG. 7 is an explanatory diagram for explaining the calculation of a band cross-section, and is a diagram schematically illustrating a cross-section corresponding to the IV-IV cross-section in FIG. 3.

FIG. 8 is a diagram that compares the transfer impedance of a braided shield in the braided shield electric wire model according to the present embodiment in which a strand bundle is modeled into a band shape, with the transfer impedance of a braided shield in a braided shield electric wire model that is the braided shield electric wire model according to a comparative example, and that includes a strand bundle model in which each strand is modeled.

FIG. 9 is a sectional view corresponding to the IV-IV cross-section in FIG. 3, when a first strand band model and a second strand band model according to the embodiment are braided, according to a modification of the embodiment.

FIG. 10 is a schematic sectional view illustrating that the length from the center to the first strand band model and the second strand band model changes periodically, according to the modification of the embodiment.

FIG. 11 is a flowchart illustrating the processing procedure of a simulation method for the braided shield electric wire according to the embodiment.

FIG. 12 is a diagram that compares the transfer impedance of the braided shield electric wire models and the braided shield electric wire.

### DETAILED DESCRIPTION OF THE PREFERRED EMBODIMENTS

Hereinafter, an embodiment according to the present invention will be described in detail with reference to the accompanying drawings. It should be understood that the invention is not limited to the embodiment. Moreover, components in the following embodiment include those that can be easily replaced by those skilled in the art, or those that are substantially the same.

### EMBODIMENT

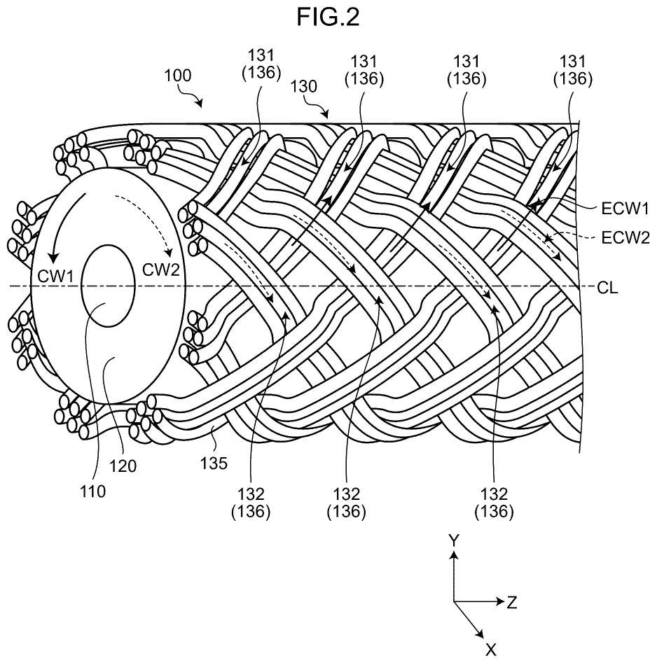

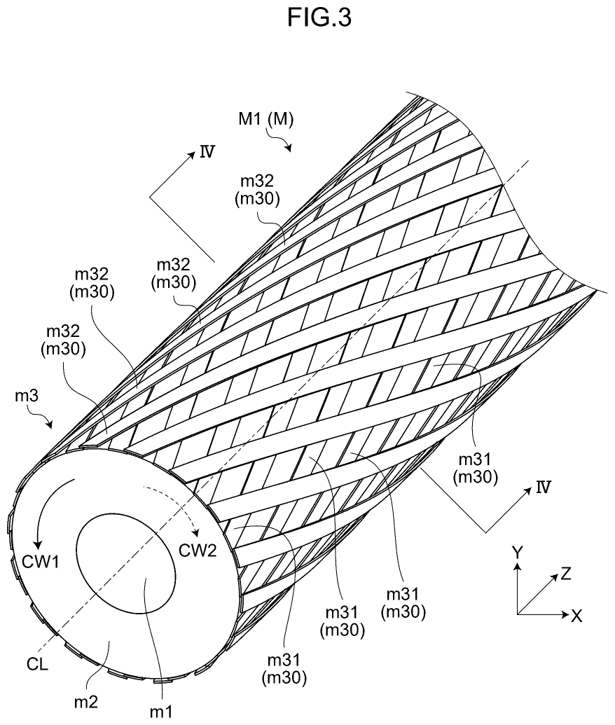

A simulation device 1 for a braided shield electric wire according to an embodiment will be described with reference to the drawings. The simulation device 1 for a braided shield electric wire 100 (see FIG. 2) is an example of a modeling device for the braided shield electric wire 100, and analyzes the shielding properties of the braided shield electric wire 100, by creating a braided shield electric wire model M (see FIG. 3) for reproducing a current flowing through a braided shield 130 (see FIG. 2) for the braided shield electric wire 100, and by performing a three-dimensional electromagnetic field simulation on the basis of the above-described braided shield electric wire model M. In the embodiment, the simulation device 1 for the braided shield electric wire 100 stores in advance mathematical equations for creating the braided shield electric wire model M, which will be described below, and creates the braided shield electric wire model M by assigning parameters to variables in the above-described mathematical equations. For example, the simulation device 1 for the braided shield electric wire 100 is implemented by various computer devices, such as a personal computer, a workstation, and a tablet terminal.

In this example, as illustrated in FIG. 2, the braided shield electric wire 100 to be simulated forms a wire harness to be installed in a vehicle, and is applied to a communication cable and a high-voltage cable, for example. The braided shield electric wire 100 includes a conductive core line 110, an insulator 120 that covers the periphery of the core line 110, and the braided shield 130 provided on the periphery of the insulator 120. The braided shield 130 includes a plurality of strand bundles 136 formed by bundling a plurality of strands 135, and is formed by braiding the strand bundles 136 together to shield noise. In this example, as illustrated in FIG. 2 and FIG. 3, in the braided shield electric wire 100 and the braided shield electric wire model M, a direction along an axis CL of the core line 110 (core line model m1) is referred to as a Z direction, and two directions orthogonal to the Z direction are each referred to as a Y direction and an X direction. Moreover, the plus side and the minus side in the X, Y, and Z directions are referred to as one side and the other side. Furthermore, a counterclockwise direction around the axis CL of the core line 110 when viewed from the other side in the Z direction is referred to as a first direction CW1, and the clockwise direction around the axis CL in the direction opposite to the first direction CW1 is referred to as a second direction CW2.

In the example of FIG. 2, the strand bundles 136 of the braided shield 130 include a plurality of first strand bundles 131 spirally provided along the first direction CW1 around the axis CL of the core line 110, and a plurality of second strand bundles 132 spirally provided along the second direction CW2 and that are braided with each of the first strand bundles 131. For example, in the braided shield 130, the diameter of each of the strands 135 is about 0.1 mm, and in the case of a high-voltage cable, the number of the strands 135 may exceed 1000 pieces. The braided shield 130 is three-dimensionally (X coordinates, Y coordinates, and Z coordinates) modeled by the simulation device 1 for the braided shield electric wire 100. Hereinafter, the simulation device 1 for the braided shield electric wire 100 will be described in detail.

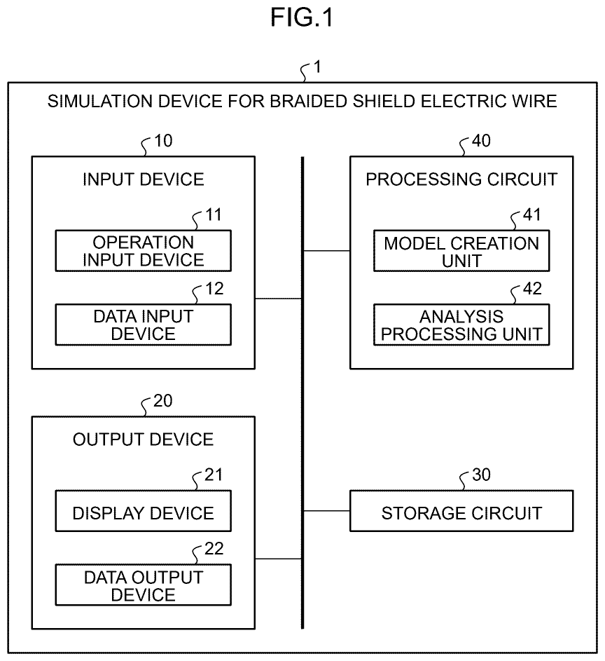

As illustrated in FIG. 1, the simulation device 1 for the braided shield electric wire includes an input device 10 serving as an input unit, an output device 20, a storage circuit 30, and a processing circuit 40. The input device 10, the output device 20, the storage circuit 30, and the processing circuit 40 are communicably connected to each other via a network.

The input device 10 is a device capable of inputting information to the simulation device 1 for the braided shield electric wire 100. For example, the input device 10 includes an operation input device 11 and a data input device 12, as devices that input various types of information to the simulation device 1 for the braided shield electric wire. The operation input device 11 is a device that receives various types of operation input (information input) from a user. For example, the operation input device 11 is implemented by a mouse, a keyboard, a trackball, a switch, a button, a joystick, a touchpad, a touchscreen, a non-contact input circuit, a voice input circuit, and the like. The data input device 12 is a device that receives various types of data input (information input) from other devices outside the simulation device 1 for the braided shield electric wire 100. For example, the data input device 12 is implemented by a communication interface that transmits and receives various types of data to and from a device via a wired or wireless communication, a recording medium interface that reads various types of data from recording media such as a hard disk drive (HDD), a solid state drive (SSD), a flexible disk (FD), a magneto-optical disk (magneto-optical disk), a CD-ROM, a DVD, a USB memory, an SD card memory, and a flash memory, and the like.

The output device 20 is a device capable of outputting information from the simulation device 1 for the braided shield electric wire 100. For example, the output device 20 includes a display device 21 and a data output device 22, as devices that output various types of information from the simulation device 1 for the braided shield electric wire 100. The display device 21 is a device that outputs and displays various types of image information. For example, the display device 21 is implemented by an image display device such as a liquid crystal display, a plasma display, and an organic EL display. The data output device 22 is a device that performs data output (information output) to other devices outside the simulation device 1 for the braided shield electric wire 100. For example, the data output device 22 is implemented by a communication interface that transmits and receives various types of data to and from a device via a wired or wireless communication, a recording medium interface that writes various types of data to a recording medium similar to the above, and the like. The data input device 12 and the data output device 22 described above may share some or all of the components.

The storage circuit 30 is a circuit that stores various types of data (information). For example, the storage circuit 30 is implemented by a semiconductor memory element such as a random access memory (RAM) and a flash memory, a hard disk, an optical disc, and the like. For example, the storage circuit 30 stores a computer program for causing the simulation device 1 for the braided shield electric wire 100 to implement various functions. The computer program stored in the storage circuit 30 includes a computer program for causing the input device 10 to function, a computer program for causing the output device 20 to function, a computer program for causing the processing circuit 40 to function (for example, a simulation program including a modeling program for the braided shield electric wire 100, which will be described below), and the like. Moreover, the storage circuit 30 stores various types of data, such as data input via the input device 10, data required for various processes in the processing circuit 40, and data output via the output device 20. The various types of data in the storage circuit 30 are read by the processing circuit 40 or the like as necessary. The storage circuit 30 may also be implemented by a cloud server or the like connected to the simulation device 1 for the braided shield electric wire 100 via a network.

The processing circuit 40 is a circuit that implements various processing functions in the simulation device 1 for the braided shield electric wire 100. For example, the processing circuit 40 is implemented by a processor. For example, the processor means a circuit such as a central processing unit (CPU), a micro processing unit (MPU), an application specific integrated circuit (ASIC), and a field programmable gate array (FPGA). For example, the processing circuit 40 implements each processing function, by executing the computer program read from the storage circuit 30.

An overview of the overall configuration of the simulation device 1 for the braided shield electric wire 100 according to the present embodiment has been described. Under such a configuration, as illustrated in FIG. 3 to FIG. 5 and in FIG. 9, the processing circuit 40 according to the present embodiment analyzes the shielding properties of the braided shield electric wire 100, by creating the braided shield electric wire model M for reproducing a current flowing through the braided shield 130 for the braided shield electric wire 100, and by performing a three-dimensional electromagnetic field simulation on the basis of the above-described braided shield electric wire model M. As illustrated in FIG. 1, the processing circuit 40 includes a model creation unit 41 and an analysis processing unit 42.

The model creation unit 41 creates the braided shield electric wire model M for reproducing a current flowing through the braided shield 130 for the braided shield electric wire 100.

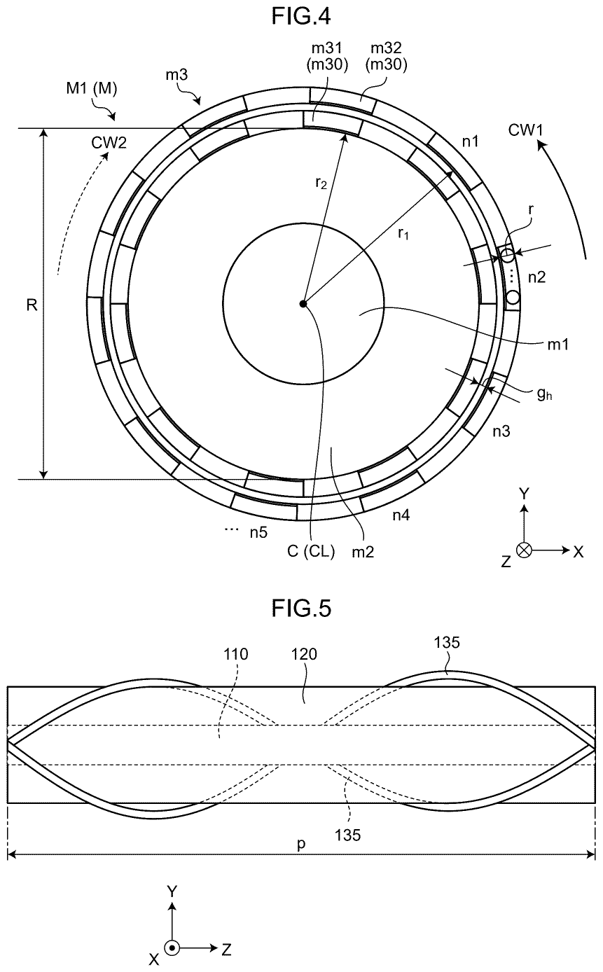

For example, as illustrated in FIG. 3 and FIG. 4, the model creation unit 41 creates the braided shield electric wire model M that includes a core line model m1 corresponding to the core line 110, an insulator model m2 corresponding to the insulator 120, and a braided shield model m3 corresponding to the braided shield 130. The center C in FIG. 4 is the center point of the core line model m1 (braided shield model m3) on the axis CL. The braided shield model m3 includes a plurality of strand band models m30 in which each of the strand bundles 136 is modeled into a band shape. The strand band models m30 are separated from each other in the radial direction of the braided shield electric wire model M. The braided shield model m3 of a braided shield electric wire model M1 according to the present embodiment includes a first strand band model m31 and a second strand band model m32 in which each of the first strand bundle 131 and the second strand bundle 132 is modeled as the strand band model m30. The first strand band model m31 and the second strand band model m32 of the braided shield model m3 in the braided shield electric wire model M1 are modeled without being braided together. Then, the second strand band model m32 is disposed outside the first strand band model m31. The first strand band model m31 and the second strand band model m32 are separated from each other in the radial direction of the braided shield electric wire model M1.

By assigning parameters to the variables in the following equation (1) to equation (8), the model creation unit 41 creates the braided shield electric wire model M1 described above, by sweeping the cross-sectional shape of the strand band model m30. The equation (1) to equation (8) are stored in the storage circuit 30 in advance. The parameters to be assigned to the variables in the equation (1) to equation (8) are input via the input device 10. As illustrated in FIG. 3 to FIG. 5, the model creation unit 41 creates the braided shield electric wire model M1 that satisfies the following equations (1) to (8), by setting the coordinates on the three-dimensional coordinates to x, y, and z, the diameter of the strand 135 to r, the diameter of the insulator 120 to R, the length of the circumference around the axis CL of the strand 135 to p, the total number of bundles (number of hits) of the first strand bundle 131 and the second strand bundle 132 to n, the gap between the strand band models m30 in the radial direction (gap between the first strand band model m31 and the second strand band model m32 in the radial direction) to gₕ, a predetermined value on the three dimensional coordinates to t, the distance from the center C of the core line model m1 to the second strand band model m32 to r₁, and the distance from the center C of the core line model m1 to the first strand band model m31 to r₂. In other words, the braided shield electric wire model M1 created by the model creation unit 41 satisfies the following equations (1) to (8). The equation (1) to equation (4) represent the first strand band models m31 spirally formed along the first direction CW1 around the axis CL of the core line model m1, and the equation (5) to equation (8) represent the second strand band models m32 spirally formed along the second direction CW2 in the direction opposite to the first direction CW1 around the axis CL of the core line model m1. In FIG. 4, the diameter r of the strand 135 and the diameter R of the insulator 120 are applied to the braided shield electric wire model M1.

$$x = {r}_{1} sin \frac{2 π}{p} t \qquad ( 1 )$$

$$y = {r}_{1} cos \frac{2 π}{p} t \qquad ( 2 )$$

$$z = t + \frac{2 p}{n} l ( l = 0 , 1 , 2 , … , \frac{n}{2} - 1 ) \qquad ( 3 )$$

$${r}_{1} = ( R + r ) / 2 \qquad ( 4 )$$

$$x = - {r}_{2} sin \frac{2 π}{p} t \qquad ( 5 )$$

$$y = {r}_{2} cos \frac{2 π}{p} t \qquad ( 6 )$$

$$z = t + \frac{p}{n} + \frac{2 p}{n} l ( l = 0 , 1 , 2 , … , \frac{n}{2} - 1 ) \qquad ( 7 )$$

$${r}_{2} = ( R + 3 r + 2 {g}_{h} ) / 2 \qquad ( 8 )$$

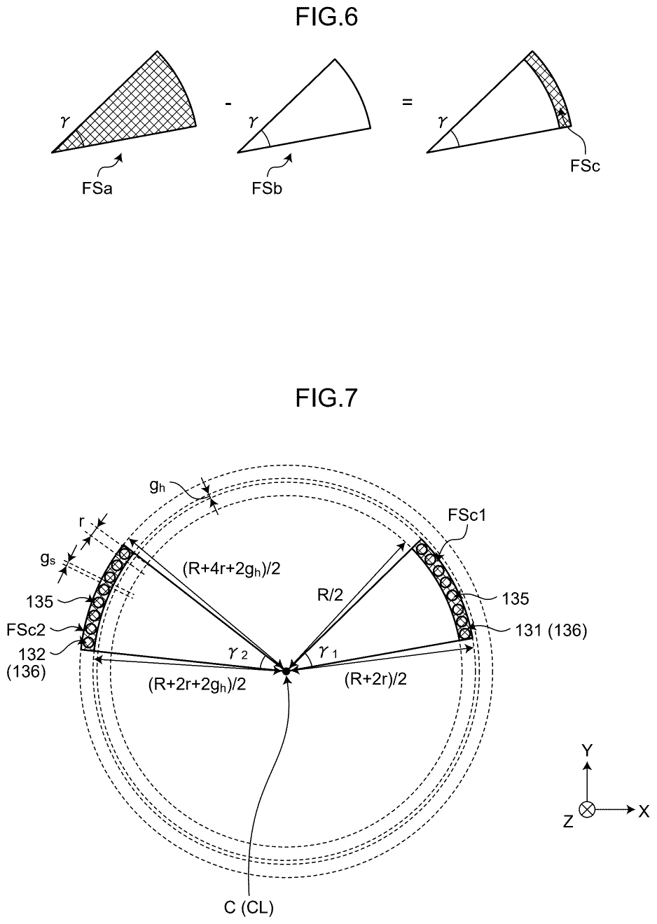

To model the strand bundle 136 into a band shape, the sectional shape of the band-shaped strand bundle 136 (the cross-sectional shape of the surface orthogonal to the axis CL of the strand band model m30, hereinafter, referred to as a “band cross-section”) is calculated by the model creation unit 41, and the band cross-section is swept by the coordinates x, y, and z on the three-dimensional coordinates represented by the equations (1) to (8). As illustrated in FIG. 6, a band cross-section FSc having a cross-sectional shape can be calculated, by drawing a fan shape FSa at the outer diameter and a fan shape FSb at the inner diameter of the strand bundle 136 using a computer aided design (CAD), and subtracting the fan shape FSb from the fan shape FSa. In this example, the central angles γ of the fan shapes FSa and FSb are the same.

Specifically, as illustrated in FIG. 7, by setting the diameter of the strand 135 to r, the diameter of the insulator 120 to R, the gap between the strand band models m30 in the radial direction to gₕ, and the central angle of the fan shapes FSa and FSb to vi, in the first strand bundle 131 (the first strand band model m31 after being modeled), a band cross-section FSc1 can be calculated by subtracting the fan shape FSb whose radius is R/2 from the fan shape FSa whose radius is (R+2r)/2. The central angle γ₁ can be calculated using the following equation (9), by setting the gap between the strands 135 around the axis CL to gₛ, and setting the total number of bundles (number of possessions) of the first strand bundle 131 and the second strand bundle 132 to m. Similarly, in the second strand bundle 132 (the second strand band model m32 after being modeled), by setting the central angle of the fan shapes FSa and FSb to γ₂, a band cross-section FSc2 can be calculated by subtracting the fan shape FSb whose radius is (R+2r+2gₕ)/2 from the fan shape FSa whose radius is (R+4r+2gₕ)/2. In this process, the central angle γ₂ of the fan shapes FSa and FSb can be calculated using the following equation (10).

$${γ}_{1} = \frac{2 rm + 2 {g}_{s} ( m - 1 )}{R + 2 r} \qquad ( 9 )$$

$${γ}_{2} = \frac{2 rm + 2 {g}_{s} ( m - 1 )}{R + 4 r + 2 {g}_{h}} \qquad ( 10 )$$

In the braided shield electric wire model M1, the shielding properties of the braided shield electric wire 100 is analyzed by the analysis processing unit 42. For example, the analysis processing unit 42 can output transfer impedance Zt (Ω/m) with respect to the frequency (MHz).

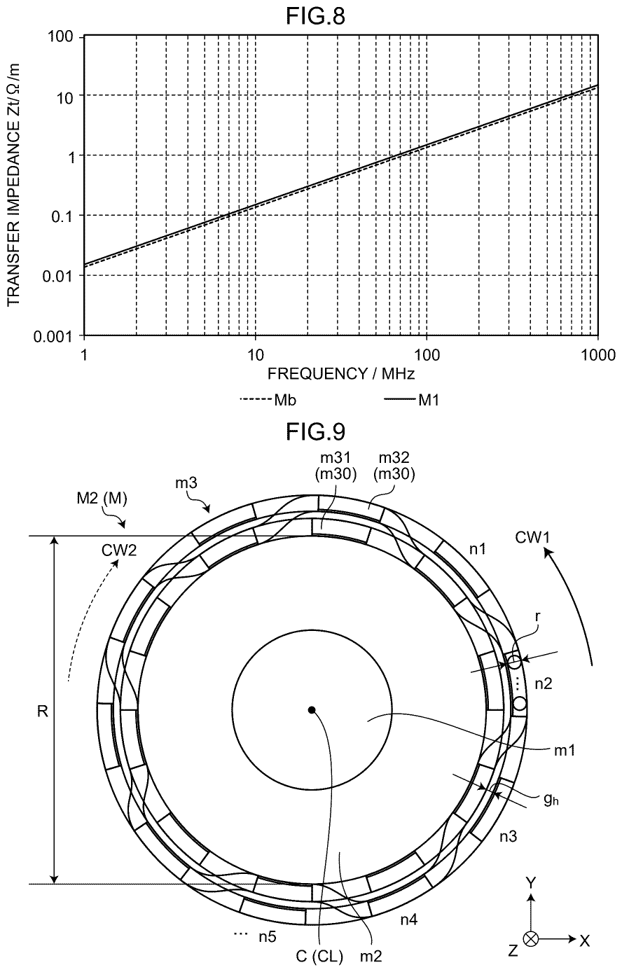

FIG. 8 is a graph that compares the shielding properties of the braided shields between the braided shield electric wire model M1 of the present embodiment and a braided shield electric wire model Mb created as a comparative example. In the braided shield electric wire model Mb, the strand bundles 136 are not modeled into a band shape, but the strand bundle 136 is modeled as the strand bundle model, by modeling each of the strands 135 one by one. In the braided shield electric wire model Mb serving as a comparative example, the adjacent strands 135 around the axis CL do not come into contact with each other. Moreover, in the braided shield electric wire model Mb in the comparative example, the strand bundle model is not braided. As apparent from FIG. 8, there is almost no difference in the shielding properties between the braided shield electric wire model M1 of the present embodiment in which the strand bundles 136 are modeled into a band shape as in the present embodiment, and the braided shield electric wire model Mb of the comparative example in which the strand bundles 136 are not modeled into a band shape.

The reasons can be explained as follows. To analyze the shielding properties of the braided shield 130, there is a need to reproduce the current flow in the braided shield 130. The current flowing through the braided shield 130 flows in the clockwise direction (current ECW2 illustrated in FIG. 2) and in the counterclockwise direction (current ECW1 illustrated in FIG. 2) for each strand bundle 136. The magnetic field generated by one of the strands 135 is represented by I/(2πd), by setting the distance from the strand 135 to d, and the current flowing in the strand 135 to I. The magnetic field generated by the strand bundle 136 is represented using the current value obtained by summing up the current flowing through each strand 135 forming the strand bundle 136. Moreover, when a single model is formed by combining the strand models of the strand bundle 136 into a band shape, the flowing current value is the current value obtained by summing up the current flowing in each strand 135. Therefore, the magnetic fields generated in the strand bundle 136 are the same, when each of the strands is modeled as the strand bundle model, and when the strand models that configure the strand bundle 136 are combined into a band shape and made into a single model as the strand band model. In this manner, even if contact is made, the magnetic field generated in the strand bundle 136 is the same, and does not affect the shielding properties. Therefore, in the strand bundle 136, the model of the braided shield 130 is simplified, by combining the strands 135 into a single band-shaped model (strand band model m30). Moreover, in the actual braided shield electric wire 100, there is a contact resistance between the first strand bundle 131 and the second strand bundle 132, and current does not flow therebetween. To reproduce this in a pseudo manner, a gap (gap gₕ) is provided between the first strand band model m31 and the second strand band model m32 such that the first strand band model m31 and the second strand band model m32 do not come into contact with each other, and preventing current from flowing therebetween. In this manner, the actual current flow is reproduced.

In the braided shield electric wire model Mb compared in FIG. 8, the strands 135 are modeled one by one. Hence, when there are a large number of strands (for example, 1000 pieces or more) in the braided shield 130, modeling takes time. However, according to the braided shield electric wire model M1 of the present embodiment, the strand bundle 136 can be modeled into a single band-shaped model (strand band model m30). Hence, compared to modeling the braided shield electric wire model Mb, the time required for modeling can be significantly reduced.

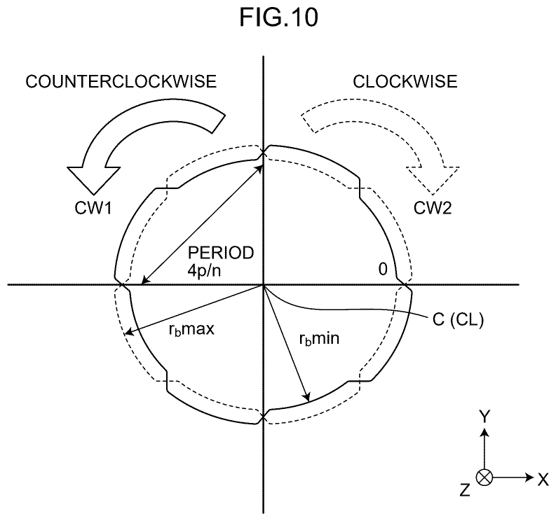

Next, as a modification of the present embodiment, as illustrated in FIG. 9 and FIG. 10, the braided shield electric wire 100 can also be modeled, by braiding the first strand band model m31 and the second strand band model m32 together. In this case, by assigning parameters to the variables in the following equation (11) to equation (18), the model creation unit 41 creates a braided shield electric wire model M2 that includes the first strand band model m31 and the second strand band model m32 by sweeping the band cross-section. The equation (11) to equation (18) are stored in the storage circuit 30 in advance. The parameters to be assigned to the variables in the equation (11) to equation (18) are input via the input device 10. The model creation unit 41 creates the braided shield electric wire model M2 that satisfies the following equations (11) to (18), by setting the coordinates on the three-dimensional coordinates to x, y, and z, and as illustrated in FIG. 9, by setting the diameter of the strand 135 to r, the diameter of the insulator 120 to R, the length of the circumference around the axis CL of the strand 135 to p (see FIG. 5), the total number of bundles (number of hits) of the first strand bundle 131 and the second strand bundle 132 to n, the gap between the strand band models m30 in the radial direction to gₕ, a predetermined value on the three dimensional coordinates to t, and the distance from the center C of the core line model m1 to the first strand band model m31 and the second strand band model m32 to r_{b}. In other words, the braided shield electric wire model M2 created by the model creation unit 41 satisfies the following equations (11) to (18). In the present embodiment, the first strand band model m31 and the second strand band model m32 are braided together. Hence, as illustrated in FIG. 10, the distance r_{b} is alternately represented by the maxim value of r_{b}max and the minimum value of r_{b}min at a period of 4p/n (equation (14), equation (18)). The equation (11) to equation (14) represent the first strand band models m31 spirally formed along the first direction CW1 around the axis CL of the core line model m1, and the equation (15) to equation (18) represent the second strand band models m32 spirally formed along the second direction CW2 in the direction opposite to the first direction CW1 around the axis of the core line model m1. In FIG. 9, the diameter r of the strand 135 and the diameter R of the insulator 120 are applied to the braided shield electric wire model M2.

$$x = {r}_{b} sin \frac{2 π}{p} t \qquad ( 11 )$$

$$y = {r}_{b} cos \frac{2 π}{p} t \qquad ( 12 )$$

$$z = t + \frac{2 p}{n} l ( l = 0 , 1 , 2 , … , \frac{n}{2} - 1 ) \qquad ( 13 )$$

$${r}_{b} = \frac{R + 2 r}{2} + \frac{2 ( r + {g}_{h} )}{π} {\sum }_{k = 1}^{∞} \frac{1}{2 k - 1} sin \{ ( 2 k - 1 ) \frac{n π}{2 p} t \} \qquad ( 14 )$$

$$x = - {r}_{b} sin \frac{2 π}{p} t \qquad ( 15 )$$

$$y = {r}_{b} cos \frac{2 π}{p} t \qquad ( 16 )$$

$$z = t + \frac{p}{n} + \frac{2 p}{n} l ( l = 0 , 1 , 2 , … , \frac{n}{2} - 1 ) \qquad ( 17 )$$

$${r}_{b} = \frac{R + 2 r}{2} + \frac{2 ( r + {g}_{h} )}{π} {\sum }_{k = 1}^{∞} \frac{1}{2 k - 1} sin \{ ( 2 k - 1 ) \frac{n π}{2 p} t \} \qquad ( 18 )$$

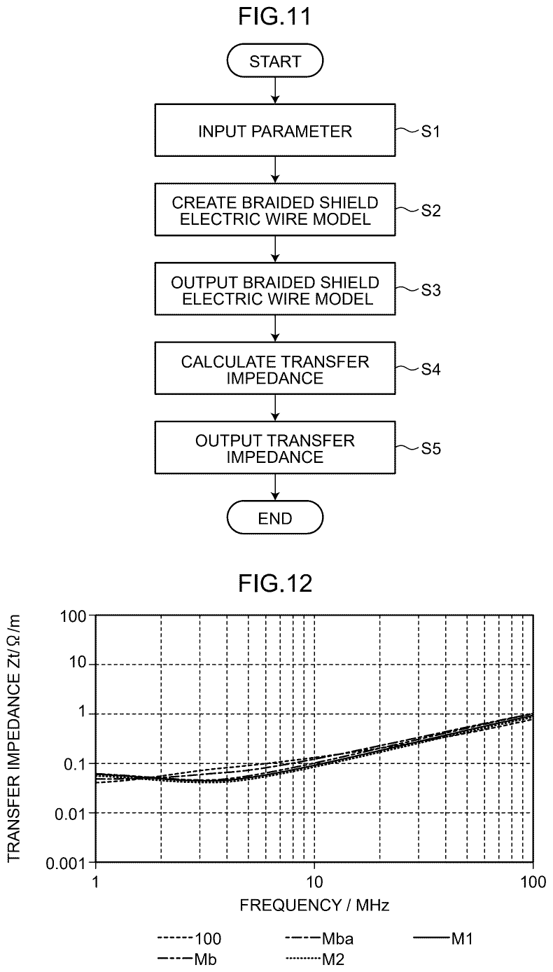

Next, with reference to FIG. 11, the processing procedure of a simulation method for the braided shield electric wire 100 in the simulation device 1 for the braided shield electric wire 100 will be described. As illustrated in FIG. 11, the simulation method for the braided shield electric wire 100 includes an input step S1 for inputting a parameter, a model creation step S2 for creating the braided shield electric wire model M, a model output step S3 for outputting the braided shield electric wire model M, a calculation step S4 for calculating transfer impedance, and a result output step S5 for outputting the transfer impedance. The simulation device 1 for the braided shield electric wire 100 executes the input step S1, the model creation step S2, the model output step S3, the calculation step S4, and the result output step S5 described above, by executing the simulation program for the braided shield electric wire 100 stored in advance in the storage circuit 30.

In the simulation device 1 for the braided shield electric wire, the input device 10 executes the input step S1 for inputting a parameter to be assigned to the variable in the equation (1) to equation (8) or the equation (11) to equation (18) described above via the operation input device 11. For example, the input device 10 inputs “20” as a parameter to be assigned to the variable “n” that is the total number of bundles (number of hits) of the first strand bundle 131 and the second strand bundle 132. Moreover, the input device 10 inputs a predetermined value serving as a parameter to be assigned to the variable “r” that is the diameter of the strand 135, the variable “R” that is the diameter of the insulator 120, the variable “p” that is the length of the circumference around the axis CL of the strand 135, and the variable “gₕ” that is the gap between the strand band models m30 in the radial direction.

Next, the model creation unit 41 of the processing circuit 40 executes the model creation step S2 for creating the braided shield electric wire model M (M1, M2), by assigning the parameter input at the input step S1 to the variable in the equation (1) to equation (8) or the equation (11) to equation (18). For example, as illustrated in FIG. 3 and FIG. 4, the model creation unit 41 creates the braided shield electric wire model M1 in which the first strand band model m31 and the second strand band model m32 are not braided together, or the braided shield electric wire model M2 in which the first strand band model m31 and the second strand band model m32 are braided together, that includes a layer in which the first strand band models m31 are spirally formed along the first direction CW1 around the axis CL of the core line model m1, and a layer provided outside the above-described layer (that is, the first strand band model m31) in a state of being separated from the layer, and in which the second strand band models m32 are spirally formed along the second direction CW2 in the direction opposite to the first direction CW1 around the axis CL of the core line model m1.

Next, the model creation unit 41 of the processing circuit 40 executes the model output step S3 for outputting the braided shield electric wire model M (M1, M2) created at the model creation step S2 to the analysis processing unit 42. At the model output step S3, the model creation unit 41 may also output the braided shield electric wire model M to the storage circuit 30, and store the braided shield electric wire model M (M1, M2) in the storage circuit 30.

Next, on the basis of the braided shield electric wire model M (M1, M2) output by the model creation unit 41, the analysis processing unit 42 of the processing circuit 40 executes the calculation step S4 for calculating the shielding properties (transfer impedance) of the braided shield electric wire.

Next, the output device 20 executes the result output step S5 for outputting the shielding properties (transfer impedance) of the braided shield electric wire 100 calculated at the calculation step S4. For example, as the simulation result, the output device 20 displays the shielding properties (transfer impedance) of the braided shield electric wire 100 on the display device 21, and terminates the process.

As illustrated in FIG. 12 serving as a graph that compares the transfer impedance of the coaxial shield electric wire models and the braided shield electric wire 100, it is known that the transfer impedance between the braided shield electric wire model M1 that is modeled without braiding the first strand band model m31 and the second strand band model m32 together, and the braided shield electric wire model M2 that is modeled by braiding the first strand band model m31 and the second strand band model m32 together, have the similar results. Furthermore, even when the braided shield electric wire model Mb described above, in which the strands 135 are modeled one by one without braiding, a braided shield electric wire model Mba in which the strands 135 are modeled one by one and are braided, and the braided shield electric wire models M1 and M2 are compared, the transfer impedance have the similar results. Even when the actual measurement values of the braided shield electric wires 100 in the braided shield electric wire models M1, M2, Mb, and Mba are compared, the transfer impedance have the similar results.

The simulation device 1 that is the modeling device for the braided shield electric wire 100 described above, includes the model creation unit 41 that creates the braided shield electric wire model M (M1, M2) for reproducing a current flowing through the braided shield 130 for the braided shield electric wire 100 that includes the conductive core line 110, the insulator 120 that covers the periphery of the core line 110, and the braided shield 130 that is provided on the periphery of the insulator 120 and that is provided with the strand bundles 136 formed by bundling the strands 135. The braided shield electric wire model M (M1, M2) includes the core line model m1 corresponding to the core line 110, the insulator model m2 corresponding to the insulator 120, and the braided shield model m3 corresponding to the braided shield 130. The braided shield model m3 includes the strand band models m30 in which the strand bundle 136 is modeled into a band shape, and the strand band models m30 are separated from each other.

Consequently, even if the braided shield 130 includes a large number of strands 135, there is no need to model each of the strands 135 one by one, and the strand bundle 136 is modeled as the strand band model m30 as a single model. Hence, it is possible to reduce the time required for modeling the braided shield electric wire 100, by creating a simple braided shield electric wire model M (M1, M2). And thus, it is possible to properly shorten the time required for modeling the braided shield electric wire 100.

Moreover, the stand bundles 136 of the braided shield 130 includes the first strand bundle 131 spirally provided along the first direction CW1 around the axis CL of the core line 110, and the second strand bundle 132 spirally provided along the second direction CW2 around the axis CL in the direction opposite to the first direction CW1 and that is braided with the first strand bundle 131. The braided shield model m3 includes the first strand band model m31 and the second strand band model m32 in which each of the first strand bundle 131 and the second strand bundle 132 is modeled as the strand band model m30. The first strand band model m31 and the second strand band model m32 are modeled without being braided together, and the second strand band model m32 is disposed outside the first strand band model m31. Consequently, the time required for modeling can be further reduced, because the first strand bundle 131 and the second strand bundle 132 of the braided shield 130 that are braided together, are modeled without being braided together.

Moreover, the simulation device 1 for the braided shield electric wire 100 further includes the input device 10 serving as the input unit that inputs a parameter. The model creation unit 41 creates the braided shield electric wire model M1 on the basis of the parameter input to the input device 10. The equations (1) to (8) described above are satisfied, by setting the coordinates on the three-dimensional coordinates to x, y, and z, the diameter of the strand 135 to r, the diameter of the insulator 120 to R, the length of the circumference around the axis CL of the strand 135 to p, the total number of bundles of the first strand bundle 131 and the second strand bundle 132 to n, the gap between the first strand band model m31 and the second strand band model m32 to gₕ, a predetermined value on the three-dimensional coordinates to t, the distance from the center of the core line model m1 to the second strand band model m32 to r₁, and the distance from the center of the core line model m1 to the first strand band model m31 to r₂. Consequently, by setting parameters, it is possible to easily create various braided shield electric wire models M1.

Furthermore, the strand bundles 136 of the braided shield 130 include the first strand bundle 131 spirally provided along the first direction CW1 around the axis CL of the core line 110, and the second strand bundle 132 spirally provided along the second direction CW2 around the axis CL in the direction opposite to the first direction CW1 and that is braided with the first strand bundle 131. The braided shield model m3 includes the first strand band model m31 and the second strand band model m32 in which each of the first strand bundle 131 and the second strand bundle 132 is modeled as the strand band model m30. The first strand band model m31 and the second strand band model m32 are modeled by being braided together. Consequently, it is possible to form the braided shield electric wire model M2 in which the first strand band model m31 and the second strand band model m32 are braided, as in the case of the braided first strand bundle 131 and second strand bundle 132.

Still furthermore, the simulation device 1 for the braided shield electric wire 100 includes the input device 10 serving as the input unit that inputs a parameter. The model creation unit 41 creates the braided shield electric wire model M2 on the basis of the parameter input to the input device 10. The equations (11) to (18) described above are satisfied, by setting the coordinates on the three-dimensional coordinates to x, y, and z, the diameter of the strand 135 to r, the diameter of the insulator 120 to R, the length of the circumference around the axis CL of the strand 135 to p, the total number of bundles of the first strand bundle 131 and the second strand bundle 132 to n, the gap between the first strand band model m31 and the second strand band model m32 to gₕ, a predetermined value on the three-dimensional coordinates to t, and the distance from the center C of the core line model m1 to the first strand band model m31 and the second strand band model m32 to r_{b}. Consequently, by setting parameters, it is possible to easily create various braided shield electric wire models M2 in which the strand band model m30 is braided.

Still furthermore, the modeling method for the braided shield electric wire 100 includes: when creating the braided shield electric wire model M (M1, M2) for reproducing a current flowing through the braided shield 130 for the braided shield electric wire 100 that includes the conductive core line 110, the insulator 120 that covers the periphery of the core line 110, and the braided shield 130 provided on the periphery of the insulator 120 and that is provided with the strand bundles 136 formed by bundling the strands 135, the model creation step S2 for creating the braided shield electric wire model M (M1, M2) that includes the core line model m1 corresponding to the core line 110, the insulator model m2 corresponding to the insulator 120, and the braided shield model m3 corresponding to the braided shield 130. At the model creation step S2, the braided shield model m3 includes the strand band models m30 in which the strand bundle 136 is modeled into a band shape, and the strand band models m30 are separated from each other. Still furthermore, the modeling program for the braided shield electric wire 100 can cause a computer to execute the model creation step S2. With the modeling method described above, it is possible to properly shorten the time required for modeling the braided shield electric wire 100, and with the modeling program, it is possible to cause a computer to properly shorten the time required for modeling the braided shield electric wire 100.

The modeling device for the braided shield electric wire, the modeling method for the braided shield electric wire, and the modeling program for the braided shield electric wire according to the embodiment of the present invention described above are not limited to the embodiment described above, and various changes may be made within the scope of the claims.

In the above description, the braided shield 130 for the braided shield electric wire 100 is formed by braiding the first strand bundle 131 and the second strand bundle 132, but may also be formed by further braiding the strand bundles 136. In this case, for example, the braided shield electric wire model M1 may provide the strand band models m30 around the axis CL, outside the second strand band model m32. Moreover, the braided shield electric wire model M2 can also be modeled by further braiding the strand band models m30, as in the case of the braided shield 130 for the braided shield electric wire 100. Furthermore, in the braided shield 130 that includes the strand bundles 136, the braided shield electric wire model M may be modeled, by braiding together the strand band models m30 in which some of the strand bundles 136 are modeled into a band shape, and without braiding the strand band models m30 in which the other strand bundles 136 are modeled into a band shape. Still furthermore, in a certain braided shield electric wire model M, the braided shield electric wire model M can be created by mixing the strand band model m30 modeled into a band shape, and a strand bundle model that is not modeled into a band shape (the strands 135 are modeled one by one). Still furthermore, modeling is also possible, by setting the diameter r of the strand 135 and the gap gₕ between the first strand band model m31 and the second strand band model m32 to 0, and setting the thickness of the strand band models m30 to 0.

The computer program executed by the processor is provided by being incorporated in advance in the storage circuit 30 or the like. The computer program may also be provided by being recorded on a computer-readable storage medium as a file in an installable format for these devices or in an executable format. Moreover, the computer program may be stored on a computer connected to a network such as the Internet, and provided or distributed by being downloaded via the network.

The modeling device for the braided shield electric wire, the modeling method for the braided shield electric wire, and the modeling program for the braided shield electric wire according to the present embodiment may also be configured by appropriately combining the components of the embodiments and modifications described above.

The modeling device for the braided shield electric wire, the modeling method for the braided shield electric wire, and the modeling program for the braided shield electric wire according to the present embodiment can properly shorten the time required for modeling the braided shield electric wire.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A modeling device for a braided shield electric wire, the modeling device comprising:
a model creation unit that creates a braided shield electric wire model for reproducing a current flowing through a braided shield for a braided shield electric wire that includes a conductive core line, an insulator that covers a periphery of the core line, and the braided shield provided on a periphery of the insulator and that is provided with a plurality of strand bundles formed by bundling a plurality of strands, wherein
the braided shield electric wire model includes a core line model corresponding to the core line, an insulator model corresponding to the insulator, and a braided shield model corresponding to the braided shield,
the braided shield model includes a plurality of strand band models in which the strand bundle is modeled into a band shape, and
the strand band models are separated from each other.

2. The modeling device for the braided shield electric wire according to claim 1, wherein
the strand bundles of the braided shield include a first strand bundle spirally provided along a first direction around an axis of the core line, and a second strand bundle spirally provided along a second direction around the axis in a direction opposite to the first direction and that is braided with the first strand bundle,
the braided shield model includes a first strand band model and a second strand band model in which each of the first strand bundle and the second strand bundle is modeled as the strand band model, and
the first strand band model and the second strand band model are modeled without being braided together, and the second strand band model is disposed outside the first strand band model.

3. The modeling device for the braided shield electric wire according to claim 2, the modeling device further comprising:
an input unit that inputs a parameter, wherein
the model creation unit creates the braided shield electric wire model based on a parameter input to the input unit, and creates the braided shield electric wire model that satisfies following equations (1) to (8), by setting coordinates on three-dimensional coordinates to x, y, and z, a diameter of the strand to r, a diameter of the insulator to R, length of a circumference around the axis of the strand to p, total number of bundles of the first strand bundle and the second strand bundle to n, a gap between the first strand band model and the second strand band model to gₕ, a predetermined value on the three-dimensional coordinates to t, distance from a center of the core line model to the second strand band model to r₁, and distance from a center of the core line model to the first strand band model to r₂.
$$x = {r}_{1} sin \frac{2 π}{p} t \qquad ( 1 )$$
$$y = {r}_{1} cos \frac{2 π}{p} t \qquad ( 2 )$$
$$z = t + \frac{2 p}{n} l ( l = 0 , 1 , 2 , … , \frac{n}{2} - 1 ) \qquad ( 3 )$$
$${r}_{1} = ( R + r ) / 2 \qquad ( 4 )$$
$$x = - {r}_{2} sin \frac{2 π}{p} t \qquad ( 5 )$$
$$y = {r}_{2} cos \frac{2 π}{p} t \qquad ( 6 )$$
$$z = t + \frac{p}{n} + \frac{2 p}{n} l ( l = 0 , 1 , 2 , … , \frac{n}{2} - 1 ) \qquad ( 7 )$$
$${r}_{2} = ( R + 3 r + 2 {g}_{h} ) / 2 \qquad ( 8 )$$

4. The modeling device for the braided shield electric wire according to claim 1, wherein
the strand bundles of the braided shield include a first strand bundle spirally provided along a first direction around an axis of the core line, and a second strand bundle spirally provided along a second direction around the axis in a direction opposite to the first direction and that is braided with the first strand bundle,
the braided shield model includes a first strand band model and a second strand band model in which each of the first strand bundle and the second strand bundle is modeled as the strand band model, and
the first strand band model and the second strand band model are modeled by being braided together.

5. The modeling device for the braided shield electric wire according to claim 3, the modeling device further comprising:
an input unit that inputs a parameter, wherein
the model creation unit creates the braided shield electric wire model based on a parameter input to the input unit, and creates the braided shield electric wire model that satisfies following equations (9) to (16), by setting coordinates on three-dimensional coordinates to x, y, and z, a diameter of the strand to r, a diameter of the insulator to R, length of a circumference around the axis of the strand to p, total number of bundles of the first strand bundle and the second strand bundle to n, a gap between the first strand band model and the second strand band model to gₕ, a predetermined value on the three-dimensional coordinates to t, and distance from a center of the core line model to the first strand band model and the second strand band model to r_{b}.
$$x = {r}_{b} sin \frac{2 π}{p} t \qquad ( 9 )$$
$$y = {r}_{b} cos \frac{2 π}{p} t \qquad ( 10 )$$
$$z = t + \frac{2 p}{n} l ( l = 0 , 1 , 2 , … , \frac{n}{2} - 1 ) \qquad ( 11 )$$
$${r}_{b} = \frac{R + 2 r}{2} + \frac{2 ( r + {g}_{h} )}{π} {\sum }_{k = 1}^{∞} \frac{1}{2 k - 1} sin \{ ( 2 k - 1 ) \frac{n π}{2 p} t \} \qquad ( 12 )$$
$$x = - {r}_{b} sin \frac{2 π}{p} t \qquad ( 13 )$$
$$y = {r}_{b} cos \frac{2 π}{p} t \qquad ( 14 )$$
$$z = t + \frac{p}{n} + \frac{2 p}{n} l ( l = 0 , 1 , 2 , … , \frac{n}{2} - 1 ) \qquad ( 15 )$$
$${r}_{b} = \frac{R + 2 r}{2} + \frac{2 ( r + {g}_{h} )}{π} {\sum }_{k = 1}^{∞} \frac{1}{2 k - 1} sin \{ ( 2 k - 1 ) \frac{n π}{2 p} t \} \qquad ( 16 )$$

6. A modeling method for a braided shield electric wire, the modeling method comprising:
when creating a braided shield electric wire model for reproducing a current flowing through a braided shield for the braided shield electric wire that includes a conductive core line, an insulator that covers a periphery of the core line, and the braided shield provided on a periphery of the insulator and that is provided with a plurality of strand bundles formed by bundling a plurality of strands,
a model creation step that creates the braided shield electric wire model including a core line model corresponding to the core line, an insulator model corresponding to the insulator, and a braided shield model corresponding to the braided shield, wherein
at the model creation step, the braided shield model includes a plurality of strand band models in which the strand bundle is modeled into a band shape, and the strand band models are separated from each other.

7. A storage medium that records a modeling program for a braided shield electric wire, the storage medium recording a computer program for causing a computer to execute:
when creating a braided shield electric wire model for reproducing a current flowing through a braided shield for the braided shield electric wire that includes a conductive core line, an insulator that covers a periphery of the core line, and the braided shield provided on a periphery of the insulator and that is provided with a plurality of strand bundles formed by bundling a plurality of strands,
a model creation step that creates the braided shield electric wire model including a core line model corresponding to the core line, an insulator model corresponding to the insulator, and a braided shield model corresponding to the braided shield, wherein
at the model creation step, the braided shield model includes a plurality of strand band models in which the strand bundle is modeled into a band shape, and the strand band models are separated from each other.
